(19) United States
(12) Patent Application Publication
(10) Pub. No.: US 2011/0219455 A1
(43) Pub. Date: Sep. 8, 2011

(54) RANDOM INJECTION-BASED DEACTIVATION OF WEB-SCRAPERS

(75) Inventors: Varun Bhagwan, San Jose, CA (US); Tyrone Wilberforce Andre Grandison, San Jose, CA (US)

(73) Assignee: INTERNATIONAL BUSINESS MACHINES CORPORATION, Armonk, NY (US)

(21) Appl. No.: 12/717,683

(22) Filed: Mar. 4, 2010

(51) Int. Cl. G06F 21/00; G06F 17/00

(52) U.S. Cl. 726/26; 715/234

(57) ABSTRACT

A computer-implemented method and system for disabling scraping of electronic data. The method includes receiving an encoding of electronic data to be protected from scraping and adding random redundant code around the encoding of the electronic data upon each request for the electronic data. The electronic data having the redundant code added around the encoding thereof being rendered the same on a display as the encoding without the redundant code added.

### BACKGROUND

The present invention relates to web-scrapers, and more specifically, to random injection-based deactivation of web-scrapers.

Some web companies specialize in delivering information services to Internet servers. Their business model is predicated on the ecosystem that they build around their web pages. Typically, arbitrary developers extract or leverage information on their websites without asking permission and/or negotiating a revenue sharing agreement. This may translate into significant loss of income for these companies. Even if web-scraping is performed for acceptable reasons, source websites may wish to divert traffic away from their main servers and/or encourage such web-scrapers to switch to using the provided application programming interfaces (APIs) instead of scraping the hypertext markup language (HTML) code for technical and/or business reasons. Users who obtain data directly from the website may cause additional load on the website's servers. The data needs to be extracted from the code sent by the web-servers. Conventionally, this is performed by using web-scraping technology.

Web scraping is the act of going through the content of a website for the purpose of extracting information from it. It is typically done by means of authoring an automated agent which makes an appropriate hypertext transfer protocol (HTTP) request to the website with the desired content, and “scrapes” the content from the result of the HTTP request. The scraping (or extraction or harvesting) is used to collect content such as user-data image links as shown in FIG. 1, for example. As shown in FIG. 1, an image 10 to be harvested is shown on a web page 20 displayed via a display of a computer system (not shown). Web-scrapers must traverse the HTML code 15 in order to obtain image. Web-scrapers also collect user-comments, email addresses, or any other data of potential value from the source website as shown in FIG. 2. As shown in FIG. 2, the comment data 30 to be harvested is shown along with the HTML code 35 to be navigated when extracting the comment data 30. In FIG. 3, a conventional web server 50 is shown. The web server 50 hosts all of the web pages for a domain and includes a content code generator 55 which creates the HTML code 60 for the web pages. An end user 65 interacts with the web pages and views rendered content 70 and a web-scraper 75 (i.e., automated program) acts in a similar manner as the end user 65. The web-scraper 75 determines and selects that data to be harvested (i.e., an image, demographic info, and comment data for example) and sends an HTTP request to the web server 50 and the web server 50 generates a dynamic page as a result of the request and forwards it to a content harvester 80 for processing of the harvested content 85.

### SUMMARY

To obviate the problems mentioned above, an embodiment of the present invention provides a mechanism for forcibly disallowing automated web-scraping agents from harvesting/collecting data from a website, by obfuscating the code used to render the web page such that although the rendered web page (as viewed on the screen by an end-user) is unchanged, the code behind the web page is dynamically changed upon every fetch request. This code-poisoning technique ensures that no automated agent can reliably collect data from the website, thus rendering the agent ineffective.

According to one embodiment of the present invention, a computer-implemented method for disabling scraping of electronic data is provided. The method including receiving an encoding of electronic data to be protected from scraping and adding random redundant code around the encoding of the electronic data upon each request for the electronic data. The electronic data having the redundant code added around the encoding thereof being rendered the same on a display as the encoding without the redundant code added.

A system and computer-program product implemented the above-mentioned method is also provided.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is an image to be harvested via a conventional web-scraping technique.

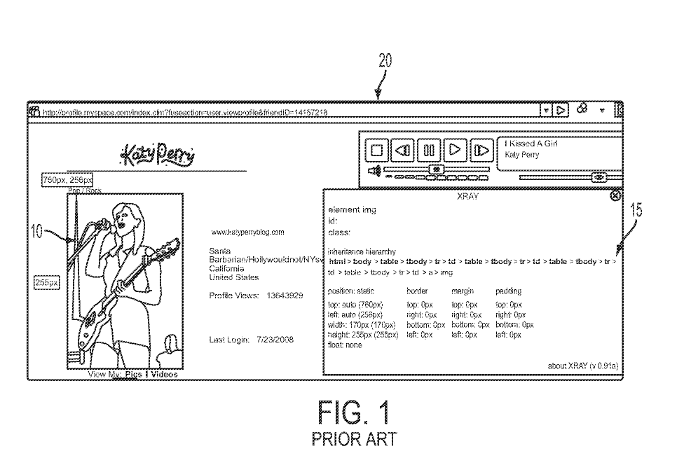

FIG. 2 is comment data to be harvested via a conventional web-scraping technique.

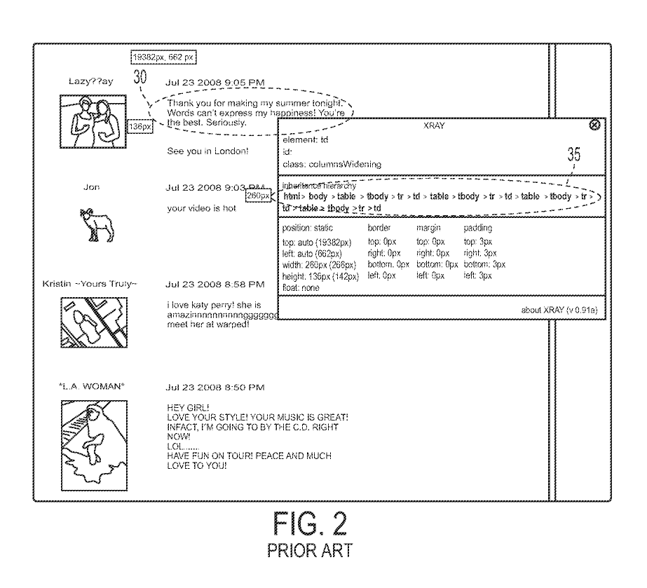

FIG. 3 is a diagram illustrating a conventional web server.

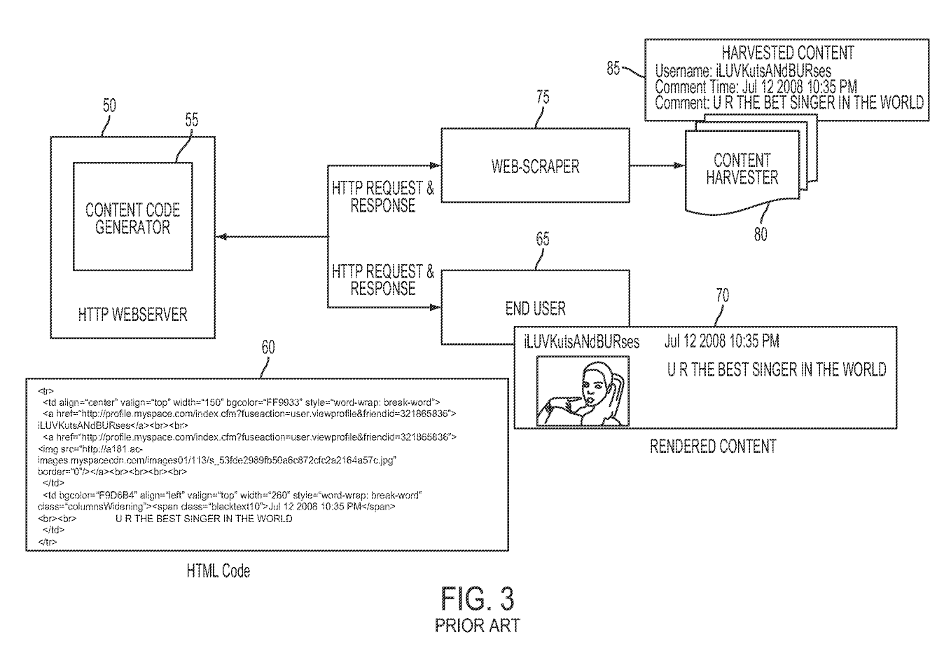

FIG. 4 is a diagram illustrating a web server enabling the injection of random HTML code into an HTTP response that can be implemented within embodiments of the present invention.

FIG. 5 is a flowchart illustrating a method of disabling scraping of electronic data that can be implemented according to an embodiment of the present invention.

### DETAILED DESCRIPTION

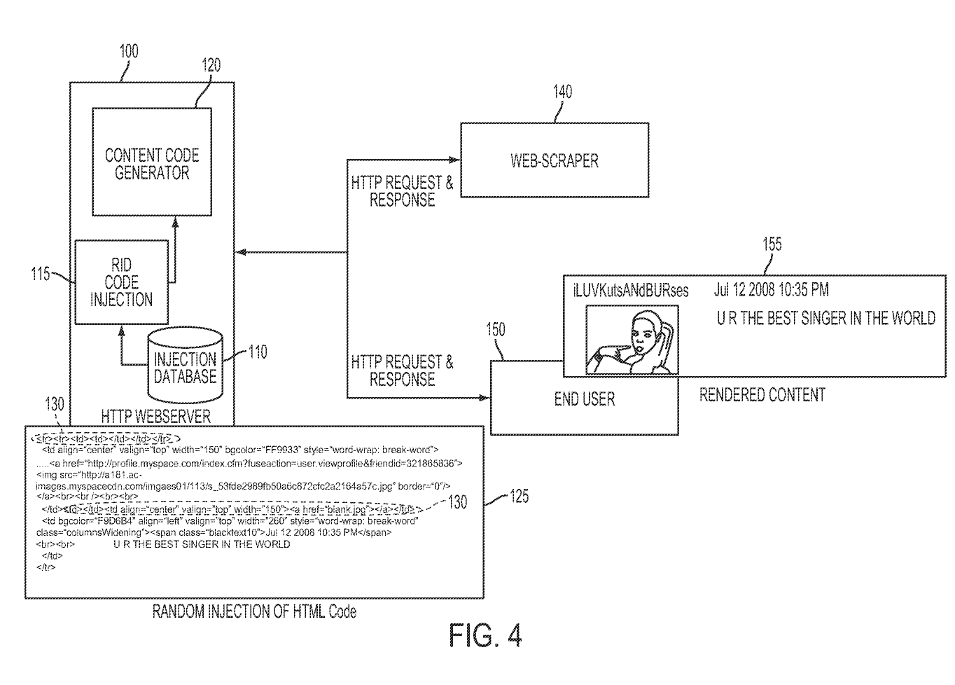

With reference now to FIG. 4, there is a web server according to an embodiment of the present invention. As shown in FIG. 4, a web server 100 having an injection database 110 storing different injection codes to be inserted into web pages and a random injection-based deactivation (RID) code injection algorithm 115 which determines where in the web page the injection code is to be injected. The algorithm 115 is used to select randomly an injection code 130 (i.e., redundant code) from the database 110 to be injected into the web page. According to an embodiment of the present invention, the injection code 130 may be html tags, for example. Also, in FIG. 4, a content code generator 120 which creates the HTML code 125 for the web pages is provided and the random injection code 130 is injected into the HTML code 125 created by the content code generator 120.

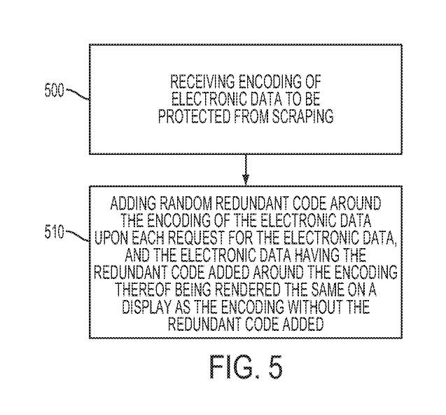

According to an embodiment of the present invention, when a web-scraper 140 sends an HTTP request to the web server 100, the web server 100 will render a HTTP response back to the web-scraper 140. The injection code 130 is injected into the HTTP response, and therefore, the web-scraper 140 is unable to retrieve data from the web page. The injection code is changed with each request for the web page content. On the other hand, an end user 150 views the web page content (i.e., the rendered content 155) via a display in the same manner without any changes. That is, the end user's experience remains the same while the web-scraping applications are deactivated non-intrusively. The present invention is not limited to being implemented within any particular computer language for rendering code and the web page content to be protected. A method for disabling scraping of electronic data such as a web page will now be described below with reference to FIG. 5.

As shown in FIG. 5, in operation 500, encoding of electronic data to be protected from scraping is received. From operation 500, the process moves to operation 510 where random redundant code is added around the encoding of electronic data upon each request for the electronic data. According to an embodiment, adding of the redundant code includes injecting random HTML code into a response to an HTTP request. According to an embodiment of the present invention, the electronic data having the redundant code added around the encoding thereof is rendered the same on a display as the encoding without the redundant code added.

According to an embodiment of the present invention, the method further includes selecting the redundant code to be added from a plurality of predetermined injection codes in a database.

According to an embodiment of the present invention, the method further includes rendering the redundant code and encoding such that the electronic data is presented in an electronic document. According to an embodiment of the present invention, the electronic document is a web page.

According to another embodiment of the present invention, the method further includes pre-generating a set of redundant code to be added to the encoding of the electronic data at appropriate locations to protect the electronic data. That is, in order to optimize the process of generating the dynamic HTTP request-result, the web server 100 “pre-generates” a set of redundant code and inserts the redundant code into the HTML code at appropriate locations. That is, the redundant code is inserted where the data needs to be hidden from the web-scraper 140.

Embodiments of the present invention provide a method which forcibly disallows automated web-scraping agents from harvesting data from a web page while displaying the web page at the end-user side unchanged.

In view of the above, the present method embodiment may also be embodied in the form of computer program code containing instructions embodied in tangible media, such as floppy diskettes, CD-ROMs, hard drives, or any other computer-readable storage medium, wherein, when the computer program code is loaded into and performed by a computer or controller, the computer becomes an apparatus for practicing the invention. The disclosure may also be embodied in the form of computer program code or signal, for example, whether stored in a storage medium, loaded into and/or performed by a computer or controller, or transmitted over some transmission medium, such as over electrical wiring or cabling, through fiber optics, or via electromagnetic radiation, wherein, when the computer program code is loaded into and performed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer-implemented method for disabling scraping of electronic data, the method comprising:
receiving an encoding of electronic data to be protected from scraping; and
adding random redundant code around the encoding of the electronic data upon each request for the electronic data, and the electronic data having the redundant code added around the encoding thereof being rendered the same on a display as the encoding without the redundant code added.

2. The computer-implemented method of claim 1, further comprising: selecting the redundant code to be added from a plurality of predetermined injection codes in a database.

3. The computer-implemented method of claim 2, further comprising rendering the redundant code and encoding such that the electronic data is presented in an electronic document.

4. The computer-implemented method of claim 3, wherein the electronic document is a web page.

5. The computer-implemented method of claim 4, further comprising: pre-generating a set of redundant code to be added to the encoding of the electronic data at appropriate locations to protect the electronic data.

6. The computer-implemented method of clam 5, wherein the pre-generated set of redundant code includes hypertext markup language tags to be added to hypertext markup language code for the web page.

7. A computer program product comprising a computer useable medium including a computer readable program, wherein the computer readable program when performed on a computer causes the computer to implement a method for disabling scraping of electronic data, the method comprising:
receiving an encoding of electronic data to be protected from scraping; and
adding random redundant code around the encoding of the electronic data upon each request for the electronic data, and the electronic data having the redundant code added around the encoding thereof being rendered the same on a display as the encoding without the redundant code added.

8. The computer program product of claim 7, wherein the method further comprising:
selecting the redundant code to be added from a plurality of predetermined injection codes in a database.

9. The computer program product of claim 8, wherein the method further comprising:
rendering the redundant code and encoding such that the electronic data is presented in an electronic document.

10. The computer program product of claim 9, wherein the electronic document is a web page.

11. The computer program product of claim 10, wherein the method further comprising:
pre-generating a set of redundant code to be added to the encoding of the electronic data at appropriate locations to protect the electronic data.

12. The computer program product method of clam 11, wherein the pre-generated set of redundant code includes hypertext markup language tags to be added to hypertext markup language code for the web page.

13. A system comprising:
a server configured to:
receive an encoding of electronic data to be protected from scraping by a web scraper; and
add random redundant code around the encoding of the electronic data upon each request for the electronic data, and the electronic data having the redundant code added around the encoding thereof being rendered at an end user is the same as the encoding without the redundant code added.

14. The system of claim 13, wherein the server comprises a storage device and is further configured to:
store predetermined injection code within the storage device.

15. The system of claim 14, wherein the server is further configured to:
select the redundant code to be added from the plurality of predetermined injection codes stored.

16. The system of claim 15, wherein the server is further configured to:
render the redundant code and encode such that the electronic data is presented in an electronic document.

17. The system of claim 16, wherein the electronic document is a web page.

18. The system of claim 17, wherein the server is further configured to:
pre-generate a set of redundant code to be added to the encoding of the electronic data at appropriate locations to protect the electronic data.

19. The system of claim 18, wherein the pre-generated set of redundant code includes hypertext markup language tags to be added to hypertext markup language code for the web page.
